(19) United States
(12) Patent Application Publication
(10) Pub. No.: US 2007/0276953 A1
(43) Pub. Date: Nov. 29, 2007

(54) DISTRIBUTION SYSTEM, INFORMATION PROCESSING APPARATUS, DISTRIBUTING METHOD AND PROGRAM

(76) Inventors: Tadashi Takeuchi, Sagamihara (JP); Aritoki Takada, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/683,462

(22) Filed: Mar. 8, 2007

(30) Foreign Application Priority Data
Apr. 13, 2006 (JP) 2006-110551

(51) Int. Cl. G06F 15/16

(52) U.S. Cl. 709/231

(57) ABSTRACT

The present invention provides a technique enabling time-shift distribution of stream data without any significant delay even when a decoder receives the stream data via a network.

Index information that is used for identifying a reproduction start time is generated into stream data distributed from an encoder by the index information generation unit 121 of the accumulation server 120. The generated index information is then transmitted to the distribution server 150 via the management server 140. The index information and the stream data are associated with each other in the distribution server 150 so as to be distributed to the decoder 160 as content information.

### CLAIM OF PRIORITY

The present application claims priority from Japanese application No. 2006-110551, filed on Apr. 13, 2006, the content of which is hereby incorporated by reference into this application.

### BACKGROUND OF THE INVENTION

The present invention relates to a technique which enables time-shift distribution of stream data.

For a technique that distributes stream data received from an encoder in a way to enable time shifting, a technique described in the Specification of U.S. Pat. No. 6,973,667 has been known.

The technique concerned buffers the stream data by using a stream server which received the stream data from an encoder. Then, upon receiving a reproduction request from the decoder, the stream server identifies an offset to the reading position of the stream data based on time information contained in the reproduction request thus received, and reads the buffered stream data from the reading position (time) to distribute the data to the decoder.

### SUMMARY OF THE INVENTION

The technique described in the Specification of the U.S. Pat. No. 6,973,667 had a problem that, in the case where a decoder and a stream server is connected via a network such as the Internet, when a data transfer delay which has occurred in the network that connects the decoder and the stream server, it takes time from when a reproduction request is transmitted to when stream data in response to the request for transmission is received in the decoder.

Therefore, the present invention provides a technique that enables time-shift distribution of stream data without any significant delay even when a decoder receives the stream data via a network.

To solve the problem stated above, the present invention is characterized by generating index information for identifying reproduction start time based on stream data received from an encoder and transmitting the index information together with the stream data to the decoder as content data.

For example, the present invention refers to a distribution system which includes an encoder, a decoder and an information processing apparatus which are connected via a network, and distributes stream data that are encoded by the encoder to the decoder via the information processing apparatus, wherein the information processing apparatus comprising: an index information generation unit which sequentially generates index information for identifying, for each data group obtained by dividing the stream data into segments in advance according to specified intervals, reproduction start time of the data groups; a content information generation unit which sequentially generates content information that includes the groups of data for which reproduction start time is identified by using the index information; and a transmission unit which sequentially transmits the content information to the decoder.

### BRIEF DESCRIPTION OF THE DRAWINGS

FIG. 1 is a schematic diagram of a distribution system 100, which is a first preferred embodiment of the present invention.

FIG. 2 is a schematic diagram of a temporary storage unit 123.

FIG. 3 is a schematic diagram of content information 190.

FIG. 4 is a flow chart for a case that a communication frame is received in an accumulation server 120 from an encoder 110.

FIG. 5 is a flow chart for a case that a data distribution request is received in a distribution server 150 from a decoder 160.

FIG. 6 is a flow chart for a case that a reproduction request is received in the decoder 160 from a user.

FIG. 7 is a schematic diagram of a distribution system 300, which is a second preferred embodiment of the present invention.

FIG. 8 is a diagram illustrating a data structure that is used for managing a list of empty blocks by a data storage unit 122.

### DESCRIPTION OF THE PREFERRED EMBODIMENTS

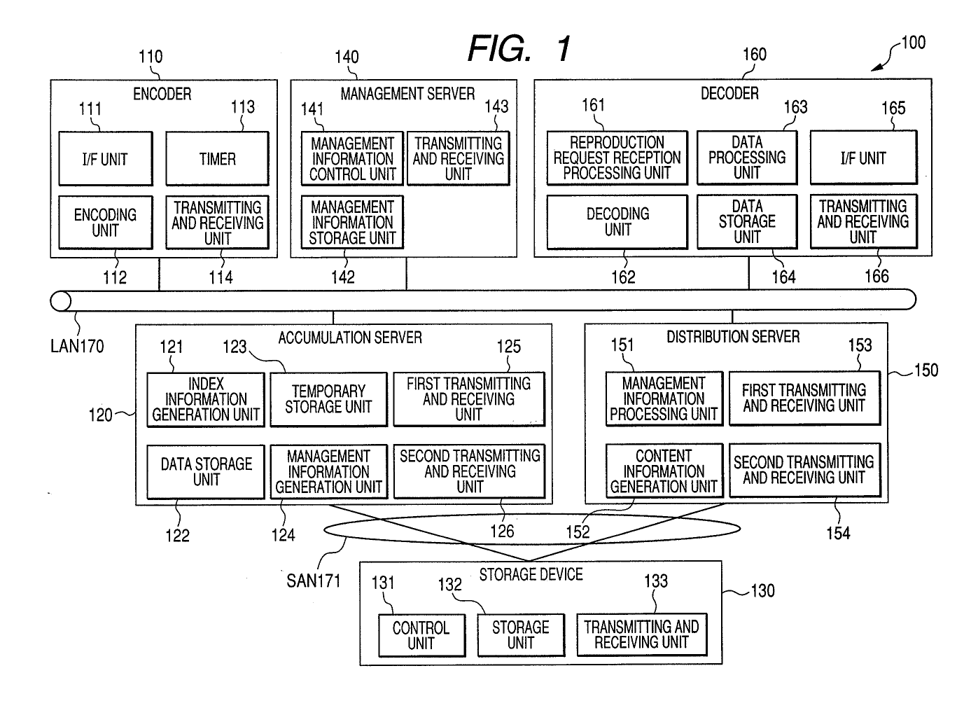

FIG. 1 is a schematic diagram of a distribution system 100, which is a first preferred embodiment of the present invention.

The distribution system 100 includes an encoder 110, an accumulation server 120, a storage device 130, a management server 140, a distribution server 150 and a decoder 160. Further, the encoder 110, the accumulation server 120, the management server 140, the distribution server 150 and the decoder 160 are connected via a LAN (Local Area Network) 170, and furthermore, the accumulation server 120 and the distribution server 150 are connected via a SAN (Storage Area Network) 171.

The encoder 110 includes an I/F unit 111, an encoding unit 112, a timer 113 and a transmitting and receiving unit 114.

The I/F unit 111 is an input interface for inputting a video image from an imaging apparatus or a video apparatus such as a video camera. It should be noted that, when a video signal to be input from an external imaging apparatus or a video apparatus is an analog signal, the video signal is converted into a digital signal at the I/F unit 111.

The encoding unit 112 encode the video signal inputted via the I/F unit 111 based on a given rule.

Here, the encoding unit 112 according to the embodiment is configured so that an image signal input via the I/F unit 111 is subjected to predictive coding, and keyframe information is added to the data body so as to be transmitted to accumulation server 120. The keyframe information is used to identify a keyframe which will be the standard for the prediction and interpolation data which is a differential value from the keyframe. The accumulation server 120 will be described later.

Further, the encoding unit 112 acquires reproduction start time for reproducing the keyframe from the timer 113 which will be described later and adds the time, as reproduction start time information, to the data body which stores the keyframe. It should be noted that, for the reproduction start time in the embodiment, time for executing encoding in the encoding unit 112 is used.

Furthermore, the encoding unit 112 adds the data size to the data body before the data is encoded.

The timer 113 measures time.

The transmitting and receiving unit 114 transmits and receives information via the LAN 170 and includes an NIC (Network Interface Card), for example.

The accumulation server 120 includes an index information generation unit 121, a data storage unit 122, a temporary storage unit 123, a management information generation unit 124, a first transmitting and receiving unit 125 and a second transmitting and receiving unit 126.

The index information generation unit 121 extracts the data body from the payload portion of the communication frame received from the encoder 110 and generates index information.

Here, the index information includes the index information size which identifies the size of the index information and the index information body.

Then, the index information generation unit 121 extracts keyframe information from the data body stored in the communication frame received from the above-stated encoder 110, and, when, according to the keyframe information thus extracted, the data contained in the data body is identified as the keyframe, the index information generation unit 121 generates index information and stores the information in the temporary storage unit 123.

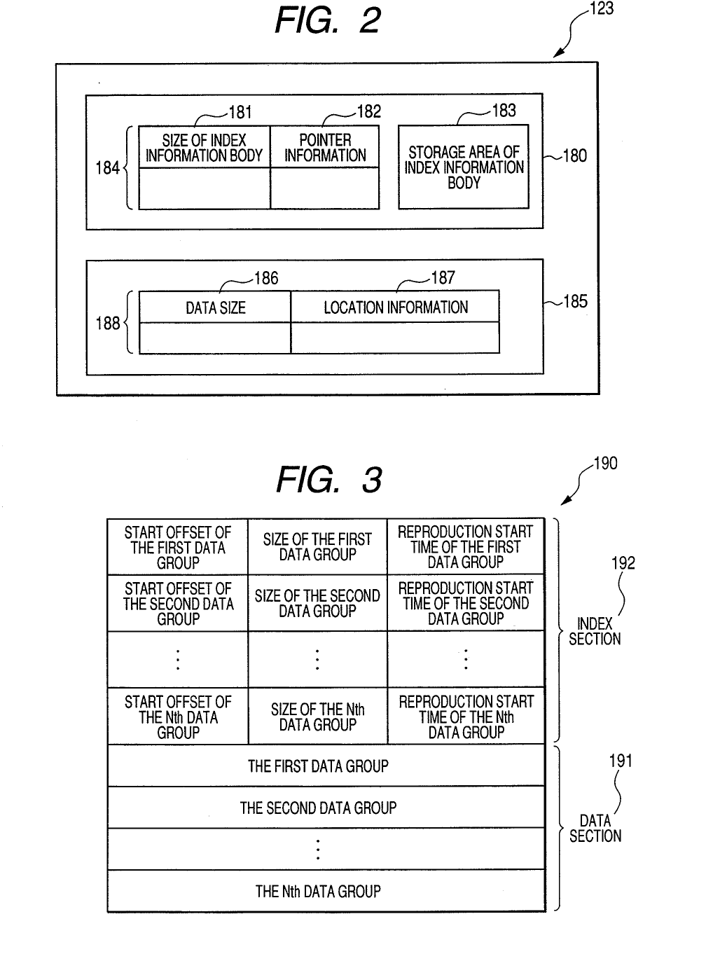

More specifically, the index information generation unit 121 extracts time information contained in the data body, a start offset showing the start position of video data in the data body and data size contained in the data body, generates the index information body by associating these information with each other, and stores the index information body in the storage area of index information body 183 of an index information storage area 180 (See FIG. 2). Further, the index information generation unit 121 registers the size of the index information body, pointer information showing the storage position where the index information body is stored in a registration column of the index information body size 181 and a registration column of pointer information 182, respectively (See FIG. 2).

On the other hand, the index information generation unit 121 extracts keyframe information from the data body stored in a communication frame that is received form the above-stated encoder 110, and, when the data contained in the data body is identified, according to the keyframe information thus extracted, to be interpolation data, the index information generation unit 121 updates the index information stored in the temporary storage unit 123.

More specifically, the index information generation unit 121 extracts a data size contained in the data body and adds the extracted data size to the data size stored in the index information body that is generated when the keyframe, which should be the base of interpolation data, is received. Further, the index information generation unit 121 calculates the size of the index information body that is modified by such processing and updates the size of the index body size stored in the registration column of the index information body size 181.

The data storage unit 122 transmits and stores the data body extracted from the payload portion of the communication frame received from the encoder 110 to the storage device 130 via a second transmitting and receiving unit 126 which is described later. Further, the data storage unit 122 registers, in a storage unit 132 of the storage device 130, position information in which the data body is stored and data size of the data body in a registration column of data size 186 and a registration column of position information 187 of a map information storage area 186, respectively, as map information (See FIG. 2).

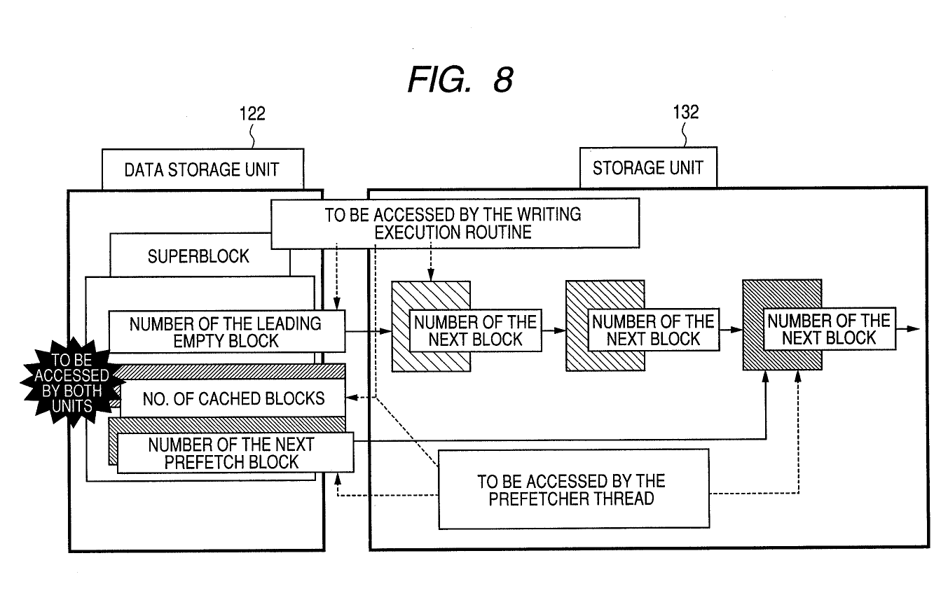

At this time, it is necessary that the data storage unit 122 should determine a position (block) of the storage unit 132 of the storage device 130 data should be written. To determine this, the data storage unit 122 executes management of a list of empty blocks shown in FIG. 8.

First, from a superblock held by the data storage unit 122, the list of empty blocks is managed. A number of the leading empty block is stored in the superblock. Further, in each empty block number stored in the storage unit 132 of the storage device 130, a empty block number next to the last number on the list is stored.

The data storage unit 122 prefetches a certain number of empty blocks starting from the leading empty block that is stored in the superblock from the storage unit 132 of the storage device 130 in advance and initiates a prefetcher thread which keeps a duplicate copy thereof in the data storage unit 122 as a cache. In addition, the data storage unit 122 adds the number of empty blocks that are cached in the data storage unit 122 and a empty block number to be prefetched next to the data structure in the superblock.

When acquiring an empty block, the writing execution routine of the data storage unit 122 updates information on the superblock or the leading empty block while maintaining a lock. If the prefetching speed of a empty block is higher than the requesting speed of the empty block, this means that the leading empty block has already been cached in the data storage unit 122, and the writing execution routine of the data storage unit 122 will not execute I/O to the storage unit while the lock is being acquired.

The prefetcher thread, after having acquired the lock, inspects the number of empty block that are cached. If the number of such empty blocks is 1 or over, it immediately releases the lock and continues prefetching operation until the number of prefetches reaches a certain number, starting from the empty block number to be prefetched next that is stored in the superblock. If the above-stated number of blocks is 1 or over, there is no possibility that the prefetcher thread refers the same empty block as the thread for which emptyblock has been acquired, the empty block list will be kept consistent. If the number of empty blocks is zero (0), acquisition of the lock is continued until the number of such empty block becomes 1 or over and prefetching operation is executed. If the prefetching speed of a empty block is higher than the requesting speed of the empty block, this means that the number of such empty blocks will be 1 or over, and the prefetcher thread will not execute I/O to the storage device 130 while the lock is being acquired.

By executing such operation to manage a list of empty blocks, execution of I/O to the storage device 130 is prevented while the lock is being acquired. Consequently, even if a plurality of writing execution routines of the data storage unit 122 are initiated in parallel, occurrence of slowdown in accumulation rate as a result of waiting for acquisition of a lock can be prevented.

The temporary storage unit 123 stores index information that is generated in the index information generation unit 121 and map information that is generated in the data storage unit 122.

For example, with the embodiment, as shown in FIG. 2 (a schematic diagram of the temporary storage unit 123), the index information storage area 180 and the map information storage area 185 are arranged in the temporary storage unit 123. Further, the index information storage area 180 includes an index information management table 184 comprising the registration column of the index information body size 181 and the registration column of pointer information 182, and the index information body storage area 183. Furthermore, the map information storage area 185 includes a map information management table 188 comprising the registration column of data size 186 and the registration column of position information 187.

The management information generation unit 124 generates management information from index information and map information stored in the temporary storage unit 123 and transmits the management information to the management server 140, which will be described later, via the first transmitting unit 125 which will also be described later.

More specifically, the management information generation unit 124 extracts keyframe information from the data body stored in the communication frame that is received from the above-stated encoder 110, and, when the keyframe is identified based on the keyframe information thus extracted, the management information generation unit 124 generates management information by associating the index information that was created when the previous keyframe was identified and was updated right before the keyframe is identified this time, with map information including the data size that was registered in the map information table 188 after the previous keyframe was stored in the storage device 130 and by the time right before the present keyframe is stored in the storage device 130, and position information.

More specifically, in the present embodiment, the index information and the map information that correspond to the keyframe and the interpolation data that is contained between such keyframe and the next keyframe are handled as a single piece of management information.

The first transmitting and receiving unit 125 transmits and receives information via the LAN 170.

The second transmitting and receiving unit 125 transmits and receives information via the LAN 171.

The accumulation server 120 which is configured as stated above can be implemented by using a computer. For example, the index information generation unit 121, the data storage unit 122 and the information generation unit 124 can be implemented by reading a prescribed program that is stored in an external storage device such as a hard disk into CPU (Central Processing Unit) and executing the program therein, and likewise, the temporary storage unit 123 by using an external storage device such as a hard disk, the first transmitting and receiving unit 125 by using an NIC, and the second transmitting and receiving unit 126 by using an HBA (Host Bus Adapter).

The storage device 130 includes a control unit 131, a storage unit 132 and a transmitting and receiving unit 133.

The control unit 131 stores a data body transmitted via the SAN 171 in the storage unit 132 which will be described later and transmits position information (a block number, for example) which stores the data body to the accumulation server 120 via the transmitting and receiving unit 133 which will also be described later.

Further, the control unit 131, when having received a request for reading data in which position information is identified from a distribution server 150 to be described later, executes control to transmit the data body that is identified by the position information to the distribution server 150.

The storage unit 132 stores the data body thus transmitted via the SAN 171. Here, in the embodiment, only addition to the data body is performed.

It should be noted that, in the present embodiment, a batch of data bodies that correspond to the keyframe and interpolation data contained between the keyframe concerned and the next keyframe are stored in the storage unit 132 as one data group.

The transmitting and receiving unit 133 is a device which transmits and receives information via the SAN 171.

The storage device 130 that is configured as stated above can be implemented by a computer. For example, the control unit 131 can be implemented by executing reading of a prescribed program that is stored in an external storage device such as a hard disk into the CPU, and likewise, the storage unit 132 by an external storage device such as a hard disk, and the transmitting and receiving unit 133 by an HBA.

The management server 140 includes a management information control unit 141, a management information storage unit 142 and a transmitting and receiving unit 143.

The management information control unit 141 stores the above-stated management information received from the accumulation server 120 in the management information storage unit 142, and, when having received a request for acquiring data in which reproduction time is designated from the distribution server 150, extracts the management information which includes index information related to reproduction time contained in the data acquisition request from the management information storage unit 142 and transmits the information to the distribution server 150 via the transmitting and receiving unit 143.

It should be noted that, for index information that is related to reproduction time contained in the data acquisition request, reproduction time of video data that corresponds to the index information is identified based on reproduction start time and size that are contained in the index information, and then, judgment is made depending on whether the reproduction time contained in the data acquisition request is contained in the reproduction time or not.

Further, the management information control unit 141, when having received a data acquisition request in which reproduction time that is already received, transmits management information in which reproduction start time after the reproduction time is contained to the distribution server 150.

Furthermore, the management information control unit 141, when having received a data acquisition request from the distribution server 150 and transmitted management information, also transmits management information that is received from the accumulation server 120 after transmitting the management information to the distribution server 150 until it receives instruction from the distribution server 150 for stopping transmission.

The management information storage unit 142 stores the above-sated management information received from the accumulation server 120.

The transmitting and receiving unit 143 transmits and receives information via the LAN 170 and includes, for example, an NIC.

The management server 140 that is configured as stated above can be implemented by a computer. For example, the management information control unit 141 can be implemented by executing reading of a prescribed program that is stored in an external storage device such as a hard disk into the CPU, and likewise, the management information storage unit 142 by an external storage device such as a hard disk, and the transmitting and receiving unit 143 by an NIC.

The distribution server 150 includes a management information processing unit 151, a content information generation unit 152, a first transmitting and receiving unit 153 and a second transmitting and receiving unit 154.

The management information processing unit 151 executes processing to transfer a data acquisition request received from the decoder 160 to the management server 140 and sends management information received from the management server 140 to the content information generation unit 152.

The content information generation unit 152 extracts map information from the management information delivered from the management information processing unit 151 and acquires from the storage device 130 a data group that corresponds to the map information thus extracted. Then, the content information generation unit 152 extracts index information from the management information from which the map information is extracted and generates content information 190 in which the index information is associated with the data group acquired.

The content information 190, for example, as shown in FIG. 3, includes a data section 191 comprising at least one data group that is acquired from the storage device 130 and an index section 192 comprising an index information body that is contained in at least one piece of index information which corresponds to the data groups contained in the data section 191.

The first transmitting and receiving unit 153 transmits and receives information via the LAN 170, and includes an NIC, for example.

The second transmitting and receiving unit 154 transmits and receives information via the LAN 170, and includes an HBA, for example.

The distribution server 150 that is configured as stated above can be implemented by a computer. For example, the management information processing unit 151 and the content information generation unit 152 can be implemented by executing reading of a prescribed program that is stored in an external storage device such as a hard disk into the CPU, and likewise, the first transmitting and receiving unit 153 by an NIC, and the second transmitting and receiving unit 154 by an HBA.

The decoder 160 includes a reproduction request reception processing unit 161, a decoding unit 162, a data processing unit 163, a data storage unit 164, an I/F unit and a transmitting and receiving unit 166.

The reproduction request reception processing unit 161 receives a reproduction request in which at least reproduction time is designated from a user terminal unit that is coupled to the reproduction request reception processing unit 161 via the I/F unit to be described later, identifies video data that corresponds to the reproduction request received from the user terminal unit according to the index section 192 that is stored in the data storage unit 164, and transmits the video data to the user terminal unit via the I/F unit 165.

It should be noted that, for the video data corresponding to the reproduction request, video data whose reproduction start time coincides with the reproduction time specified by the reproduction request or video data that contains reproduction time specified by the reproduction request may be searched in the index section 192.

Further, whether the video data contains the reproduction time specified by the reproduction request or not can be determined by specifying reproduction duration of the video data according to the reproduction start time of the data group contained in the index section 192 and to the size of such data group to see that the reproduction time is contained in the reproduction duration or not.

In addition, the reproduction request reception processing unit 161, when video data that corresponds with the reproduction request received from a user terminal unit is not stored in the data storage unit 164, transmits the data acquisition request in which the reproduction time thereof is specified to the distribution server 150 via the transmitting and receiving unit 166 which will be described later.

Furthermore, the reproduction request reception processing unit 161, when having transmitted the video data that is stored in the data storage unit 164, acquires, from the index information, the reproduction start time of the video data, out of the video data that has already been transmitted, and transmits a data acquisition request in which already-reproduced reproduction start time is specified, to the distribution server 150.

Here, to determine reproduction time that is specified in the reproduction request or already-reproduced reproduction start time, an identification code for identifying them may be included in the data acquisition request.

The decoding unit 162 extracts the original video data by combining data groups contained in the data section 191 of the content information 190 received.

The data processing unit 163 associates the original video data with the index section 192 corresponding to the video data that is decoded in the decoding unit 162 and stores the data in the data storage unit 164. More specifically, the data processing unit 163 stores the video data in the data storage unit 164 so that start position of respective video data can be identified.

In the data storage unit 164, video data that is decoded in the decoding unit 162 and the index section 192 which corresponds to the video data are stored.

The I/F unit 165 is a connector comprising information terminal units such as a TV set, a video player or a personal computer for executing transmission and reception of information to and from a user terminal unit.

The transmitting and receiving unit 166 transmits and receives information via the LAN 170 and includes an NIC, for example.

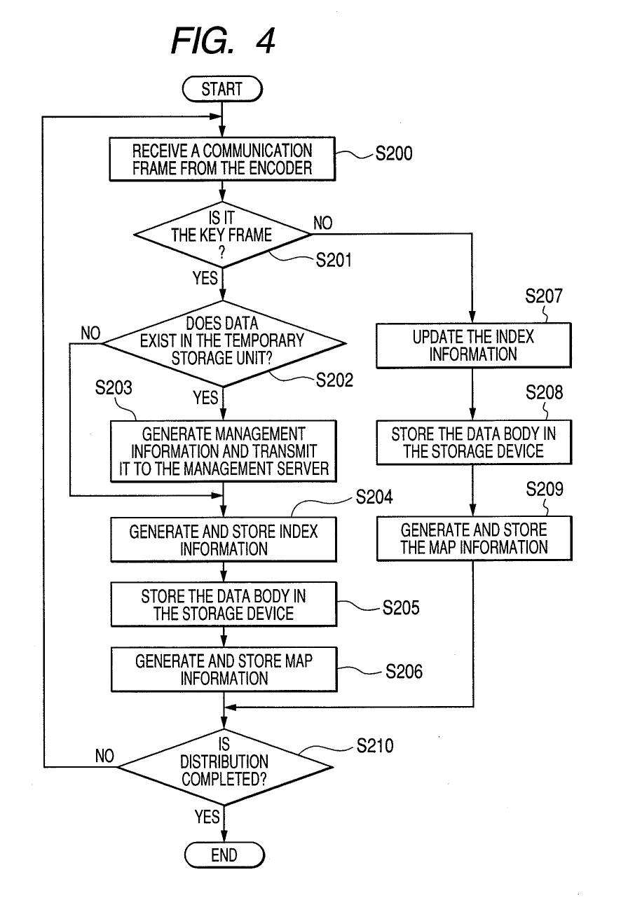

Referring to the accumulation server 120 which is configured as stated above, processing for the case of receiving a communication frame from the encoder 110 will be shown by a flow chart in FIG. 4.

First, when the accumulation server 120 receives a communication frame from the encoder 110 via the first transmitting and receiving unit 125 (S200), the index information generation unit 121 extracts keyframe information from a data body stored in the payload portion of the communication frame and determines whether the data contained in the data body is the keyframe or not (S201).

Then, if the data is the keyframe (S201), it is confirmed whether or not the data is stored in the index information storage area 180 and the map information storage area 185 of the temporary storage unit 123 (S202). When the data is stored in the areas (S202), management information is generated based on the index information and the map information stored in the index information storage area 180 and the map information storage area 185, and the management information is transmitted to the management server 140 via the first transmitting and receiving unit 125 (S203).

On the other hand, when data does not exist in the temporary storage unit 123 in Step S202, or when management information is transmitted to the management server 140 in Step S203, the index information generation unit 121 generates an index information body by extracting a start offset, a data size and reproduction start time from the data body of the keyframe, stores the index information body in the storage area of index information body 183, and registers the size and the storing position of the index information body respectively in the registration column of the index information body size 181 and the registration column of pointer information 182 (S204).

Then, the data storage unit 122 stores the data body of the keyframe in the storage device 130 via the SAN 171 (S205).

Next, the data storage unit 122 generates map information based on the information on position where the data body of the keyframe is stored in the storage device 130 and the data size of the data body and stores the map information in the map information storage area 185 (S206).

On the other hand, when the communication frame is not the keyframe (S201), the index information generation unit 122 updates the index information by extracting the size of interpolation data from the data body contained in the payload portion of the communication frame, adding the data size to the size of the index information body that is generated by the keyframe of the interpolation data, and re-registering the data size of the index information body to be modified by such processing in the registration column of the index information body size 181 (S207).

Then, the data storage unit 122 stores the data body of the interpolation data in the storage device 130 via the SAN 171 (S208).

Next, the data storage unit 122 stores the information on position where the data body of the interpolation data is stored in the storage device 130 and the data size of the data body in the map information storage area 185 (S209). It should be noted that, for storage of such information, a new entry may be created and registered in the map information management table 188 which is already generated in the map information storage area 185.

Then, processing from Steps S200 to S209 is repeated until distribution of the communication frame from the encoder 110 is completed (S210).

It should be noted that completion of distribution may be executed, for example, by transmitting identification information indicating completion of distribution to the communication frame contained in the payload portion.

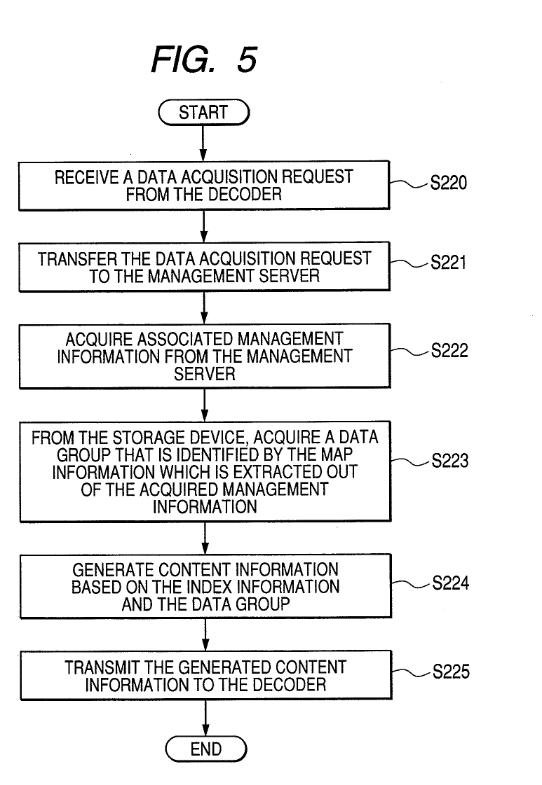

FIG. 5 is a flow chart for a case that a data distribution request is received in a distribution server 150 from a decoder 160.

First, when a data distribution request is received from the decoder 160 (S220), the management information processing unit 151 of the distribution server 150 transfers the data distribution request received to the management server 140 via the first transmitting and receiving unit 153 (S221).

Then, the distribution server 150 acquires management information by receiving management information corresponding to the data distribution request from the management server 140 (S222).

Then, the content information generation unit 152 acquires, from the storage device 130, a data group that is identified by the map information extracted out of the acquired management information (S223).

Next, the content information generation unit 152 generates content information by associating the index information extracted from the acquired control information with the data group acquired in Step S223 (S225).

The content information generated in the manner described above is transmitted to the decoder 160 via the first transmitting and receiving unit 153 (S226).

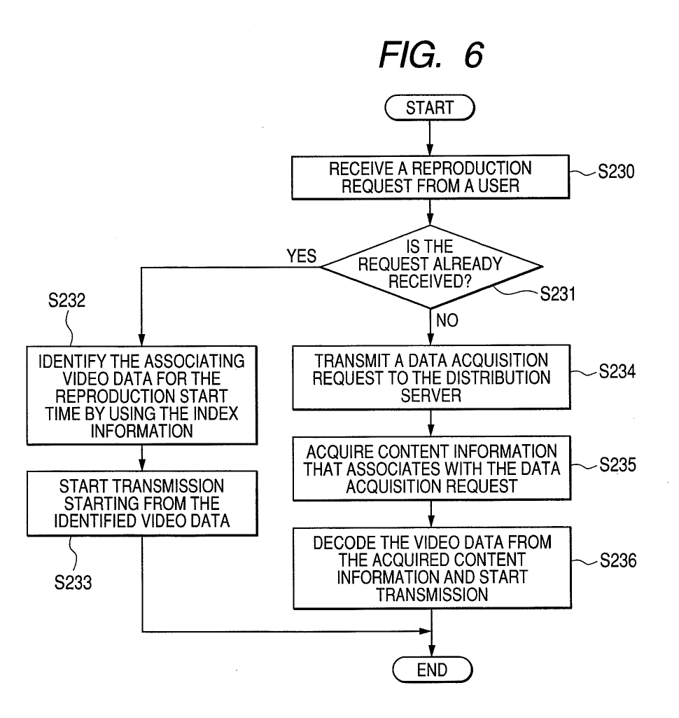

FIG. 6 is a flow chart for a case that a reproduction request is received in the decoder 160 from a user.

First, the decoder 160, when having received a reproduction request from a user via the I/F unit 165 (S230), reproduction time that is contained in the reproduction request is extracted, and confirmation is made by searching the index section 192 that is stored in the data storage unit 164 as to whether video data corresponding to the reproduction time thus extracted is already received or not (S231).

Then, when the video data is already received (S231), video data corresponding to reproduction start time is identified by using the index information (S232), and transmission of the video data is started starting from the identified video data via the I/F unit 165 (S233).

On the other hand, when the video data is not received yet (S231), a data acquisition request in which reproduction time is identified is transmitted to the distribution server 150 (S234), content information corresponding to the data acquisition request is acquired from the distribution server 150 (S235), the video data is decoded from the acquired content information, and transmission of the decoded video data is started via the I/F unit 165 (S236).

It should be noted that since management information is sequentially transmitted to the distribution server 150 from the management server 140 until distribution from the encoder 110 is completed, or until a notification of distribution completion is sent via the distribution server, and content information corresponding to the transmitted management information is transmitted to the decoder 160, the decoder 160 is arranged so that video data (stream data) can be provided to the user from when a reproduction request is delivered to when distribution is completed.

Further, for content information that is received once, since the information is stored in the data storage unit 164 so that video data is decoded for making reproduction start time identifiable, time shift distribution becomes possible within the range of video data that is stored in the data storage device 164, without bypassing the LAN 170.

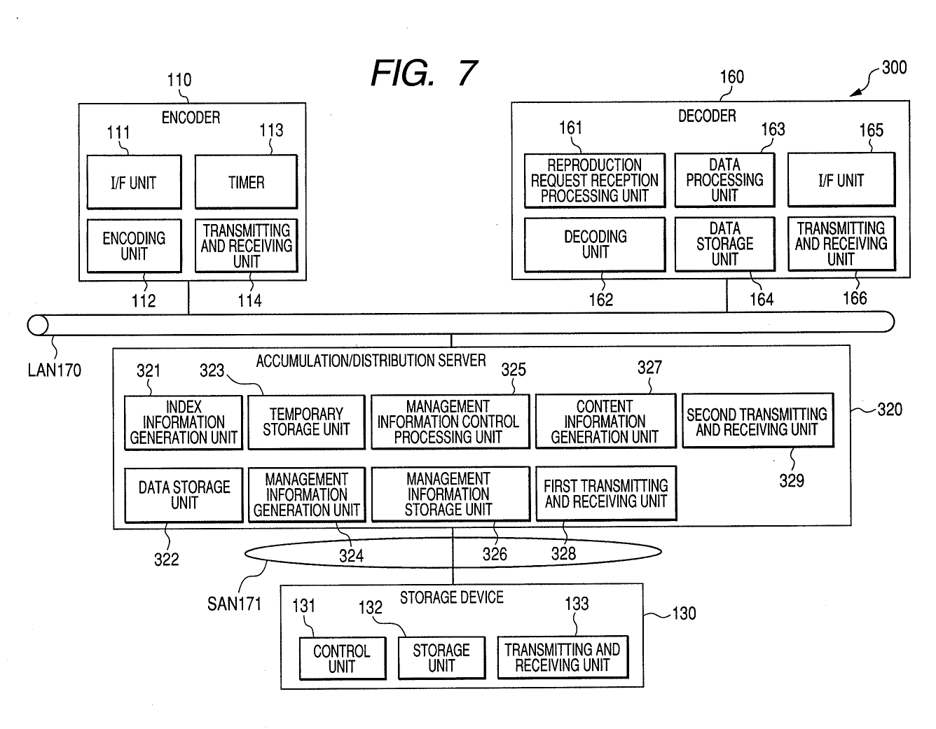

FIG. 7 is a schematic diagram of a distribution system 300, which is a second preferred embodiment of the present invention.

As illustrated in FIG. 7, the distribution system 300 includes the encoder 110, an accumulation/distribution server 320, the storage device 130, wherein the decoder 160, and the encoder 110, accumulation/distribution server 320 and the decoder 160 are connected each other via the LAN 170, and the accumulation/distribution server 320 and the storage device 130 are connected each other via the SAN 171.

Here, description of the encoder 110, the storage device 130 and the decoder 160 will be omitted since they are similar to those described in the first embodiment.

Since the present embodiment differs from the first embodiment in that processing executed by using the accumulation server 120, the management server 140 and the distribution server 150 in the first embodiment is arranged to be executed by using the accumulation/distribution server 320, items related to the difference will be described hereinafter.

The accumulation/distribution server 320 includes an index information generation unit 321, a data storage unit 322, a temporary storage unit 323, a management information generation unit 324, a management information control processing unit 325, a management information storage unit 326, a content information generation unit 327, a first transmitting and receiving unit 328 and a second transmitting and receiving unit 329.

The index information generation unit 321 executes processing similar to the index information generation unit 321 in the first embodiment.

More specifically, the index information generation unit 321 extracts a data body from the payload portion of the communication frame received from the encoder 110, generates index information to store the information in the temporary storage unit 323, and updates the index information stored in the temporary storage unit 323.

The data storage unit 322 executes processing similar to the data storage unit 122 in the first embodiment.

More specifically, the data storage unit 322 stores the data body delivered from the index information generation unit 321 in the storage device 130 via the second transmitting and receiving unit 329 which will be described later, and position information in the data body stored in the storage device 130 and the data size of the data body are stored in the temporary storage unit 323.

The temporary storage unit 323 stores information similar to that stored in the temporary storage unit 123 in the first embodiment.

More specifically, the temporary storage unit 323 stores index information generated in the index information generation unit 321 and map information generated in the data storage unit 233.

The management information generation unit 324 executes processing similar to the management information generation unit 124 in the first embodiment.

More specifically, the management information generation unit 324 generates management information based on the index information and the map information stored in the temporary storage unit 323 and stores the management information in the management information generation unit 5 324 to be described later.

The management information control processing unit 325 executes processing similar to the management information control unit 141 and the management information processing unit 151 in the first embodiment.

More specifically, the management information control processing unit 325, when having received a data acquisition request from the decoder 160, extracts management information corresponding to the data acquisition request from the management information storage unit 326 and sends the management information to the content information generation unit 327.

The management information storage unit 326 stores information similar to the management information storage unit 142 in the first embodiment.

The content information generation unit 327 executes processing similar to the content information generation unit 152 in the first embodiment.

More specifically, the content information generation unit 327 extracts map information from the management information delivered from the management information delivered from the management information control processing unit 325 and acquires from the storage device 130 a data group that corresponds to the map information thus extracted. Then, the content information generation unit 327 extracts index information from the management information from which the map information is extracted, and generates content information 190 in which the index information is associated with the data group acquired.

The first transmitting and receiving unit 328 transmits and receives information via the SAN 170 and includes an NIC, for example.

The second transmitting and receiving unit 329 transmits and receives information via the SAN 171 and includes an HBA, for example.

Description of processing to be executed in the distribution system 300 that is configured as stated above will be omitted, since the processing that is executed in a distributed manner by the accumulation server 120, the management server 140 and the distribution server 150 in the first embodiment is simply performed by the accumulation/distribution server 320.

In the second embodiment, the arrangement is such that the data body is stored in the storage unit 132 of the storage device 130. The second embodiment, however, is not limited to such an arrangement and may be applied to an arrangement in which the storage device 132 is disposed in the accumulation/distribution server 320 without providing the storage device 130.

In the embodiments stated above, the arrangement is configured such that predictive coding is performed in the encoder 110 and groups of data bodies that are delimited by keyframes are handled as one data group to generate and add a piece of index information to such data group. However, the embodiments are not limited to such an arrangement. The coding to be executed in the encoder 110 is not limited to the predictive coding. The random number of data bodies may be handled as one data group to generate and add index information to each of such data group.

According to the present information, index information for identifying reproduction start time based on stream data received from an encoder is generated and the index information is transmitted together with such stream data as content data to a decoder. Therefore, once the content data is stored in the decoder, time shifting becomes possible in the content data, which can prevent effects of delay caused by a network.

What is claimed is:

1. A distribution system which includes an encoder, a decoder and an information processing apparatus and distributes stream data that is encoded by the encoder to the decoder via the information processing apparatus, wherein
the information processing apparatus comprising:
an index information generation unit which, for each data group that is obtained by dividing the stream data into a prescribed interval, sequentially generates index information for identifying a reproduction start time of the data group; and
a content information generation unit which sequentially generate content information which includes index information that is generated in the index information generation unit, and the data group for which the reproduction start time is identified by using the index information.

2. The distribution system according to claim 1, wherein
the decoder includes a decoding unit which decodes the data group contained in the content information to generate video data;
a data storage unit which stores the video data which is decoded by the decoding unit and index information corresponding to the video data; and
a reproduction request reception processing unit which receives a reproduction request for which a reproduction time is designated from a user terminal unit,
wherein
the reproduction request reception processing unit, when video data corresponding to the reproduction time is stored in the data storage unit, transmits the video data to the user terminal unit, and when video data corresponding to the reproduction time is not stored in the data storage unit, acquires the content information corresponding to the reproduction time from the information processing apparatus.

3. The distribution system according to claim 2, wherein
the reproduction request reception processing unit calculates reproduction duration of the video data based on the reproduction start time contained in the index information and the size of the video data, and when the reproduction time is contained in the reproduction duration, judges that the video data corresponds to the reproduction time.

4. The distribution system according to claim 2, wherein
the reproduction request reception processing unit, when video data corresponding to the reproduction time is not stored in the data storage unit, transmits a data acquisition request in which the reproduction time is identified to the information processing unit, and by receiving the content information corresponding to the data acquisition request from the information processing apparatus, acquires the content information corresponding to the reproduction time.

5. The distribution system according to claim 4, wherein
the encoder transmits a communication frame storing a data body in which video data obtained by dividing the stream data is encoded to the information processing apparatus;
the communication frame contains the size of the divided video data;
the index information generation unit calculates, using at least one of the data bodies as data groups, the data size of video data corresponding to the data groups by adding the size of the divided video data corresponding to the data bodies contained in the data groups, and generates the index information containing the data size; and
the information processing apparatus calculates reproduction duration of the video data corresponding to the data groups based on the reproduction start time contained in the index information and on the data size, and transmits the content information which contains the index information in which the reproduction time contained in the data acquisition request received from the decoder is to be contained in the reproduction duration to the decoder.

6. The distribution system according to claim 1, further comprising:
an information storage unit which is connected to the information processing apparatus via a network, wherein
the information processing apparatus further includes a data storage device that stores the data groups in the information storage device; and
the content information generation unit generates the content information by using the data groups obtained from the information storage device.

7. The distribution system according to claim 1, further comprising:
an information management device that is connected to the information processing apparatus via a network, wherein
the information processing apparatus transmits the index information to the information management device, and the content information generation unit generates the content information by using the index information acquired from the information management device.

8. The distribution system according to claim 6, wherein
the data storage unit manages empty blocks of the information storage device as a list, manages the number of entries on the list of the empty blocks that are already read into the information processing apparatus from the information storage device,
until the number of entries on the list of empty blocks reaches a certain number, a thread, which reads entries of the list of empty blocks to the information processing apparatus from the information storage device first, inspects the number of entries of the list of empty blocks, and if the number of the entries is zero (0), executes an operation to read entries of the list of empty blocks after acquiring a lock, and if the number of the entries of the list of empty blocks is one or more, executes an operation to read entries of the list of empty block without acquiring the lock, and determines the storage destination of the data groups to the information storage device by reading the head entry of the empty blocks of the list that is already read into the information processing apparatus after acquiring the lock.

9. An information processing apparatus which is connected to an encoder and a decoder via a network and distributes stream data to be encoded by the encoder to the decoder, the information processing apparatus comprising:
an index information generation unit which sequentially generates index information for identifying a reproduction start time of the data groups for each data group that is obtained by dividing the stream data into a predetermined interval;
a content information generation unit which sequentially generates content information which contains index information generated by the index information generation unit, and the data groups for which the reproduction start time is identified based on the index information; and
a transmitting unit which sequentially transmits the content information to the decoder.

10. The information processing apparatus according to claim 9, the apparatus further comprising:
a data storage unit which controls processing for storing the data groups in an information storage device that is connected via a network, wherein
the content information generation unit generates the content information by using the data groups acquired from the information storage device.

11. The information processing apparatus according to claim 9, the apparatus further comprising:
a transmitting unit which transmits the index information to an information storage device that is connected via a network, wherein
the content information generation unit generates the content information by using the index information acquired from the information control device.

12. A distribution method which is performed by an information processing apparatus that is connected to an encoder and a decoder via a network and distributes stream data to be encoded by the encoder to the decoder, the distribution method comprising:
an index information generation step of sequentially generating index information for each data group that is obtained by dividing the stream data into a prescribed interval, the index information identifying a reproduction start time of the data group;
a content information generation step of sequentially generating content information that includes the index information generated in the index information generation step and the data groups in which the reproduction start time is identified by the index information; and
a transmission step of sequentially transmitting the content information to the decoder.

13. A program for executing processing by using a computer that is connected to an encoder and a decoder via a network, the program comprising:
means for sequentially generating index information for each data group that is obtained by dividing the stream data into prescribed intervals, the index information identifying a reproduction start time of the data groups;
means for sequentially generating content information that contains index information generated in the index information generation means, and the data groups in which the reproduction start time is identified by using the index information; and
means for sequentially transmitting the content information to the decoder.
